(19) United States
(12) Patent Application Publication
(10) Pub. No.: US 2021/0227198 A1
(43) Pub. Date: Jul. 22, 2021

(54) DISPLAY SYSTEM AND DISPLAY METHOD

(71) Applicants: BEIJING BOE DISPLAY TECHNOLOGY CO., LTD., Beijing (CN); BOE TECHNOLOGY GROUP CO., LTD., Beijing (CN)

(72) Inventors: Hongshu ZHANG, Beijing (CN); Xiaoling XU, Beijing (CN); Meili WANG, Beijing (CN); Yun QIU, Beijing (CN); Dan WANG, Beijing (CN); Huijuan WANG, Beijing (CN)

(21) Appl. No.: 16/309,570

(22) PCT Filed: Apr. 3, 2018
(86) PCT No.: PCT/CN2018/081704

§ 371 Date: Dec. 13, 2018

(30) Foreign Application Priority Data
Aug. 31, 2017 (CN) 201710775474.7

(51) Int. Cl. H04N 13/31; G02B 30/32

(52) U.S. Cl. CPC H04N 13/31; G02B 27/0172; G02B 30/32

(57) ABSTRACT

A display system includes: an optical waveguide, which has a first surface and a second surface in parallel with the first surface, wherein the first surface includes a light incident region and a light emergent region, and incident light from the light incident region is propagated in the optical waveguide and then is emitted from the light emergent region; and a squeezed light field module, configured to synthesize a squeezed light field including a displayed image and emit the squeezed light field to the light incident region.

### CROSS REFERENCE

The present disclosure is based on International Application No. PCT/CN2018/081704, filed on Apr. 3, 2018, which claims the benefit and priority of Chinese Patent Application No. 201710775474.7 filed on Aug. 31, 2017, the entire content of which is incorporated herein by reference as a part of the present application.

### TECHNICAL FIELD

The present disclosure generally relates to the field of display technologies, and more particularly, to a display system and a display method.

### BACKGROUND

In the existing field of display, when a user wears or views a 3D display device, a displayed 3D object is a stereoscopic vision formed by respectively displaying different images to the left and right eyes of the user. The problem of convergence-accommodation conflict existing in the 3D display based on binocular stereoscopic vision causes eye fatigue and dizziness when the user wears the 3D display device for a long time, which is a problem to be solved urgently in stereoscopic display. Therefore, it is a technical problem to be solved urgently at present to design a new display system and a new display method.

The above-mentioned information disclosed in this Background section is only for the purpose of enhancing the understanding of background of the present disclosure and may therefore include information that does not constitute a prior art that is known to those of ordinary skill in the art.

### SUMMARY

Other features and advantages of the present disclosure will become apparent from the following detailed description, or in part, be acquired by practice of the present disclosure.

According to a first aspect of the present disclosure, there is disclosed a display system, which includes:

an optical waveguide, having a first surface and a second surface in parallel with the first surface, the first surface comprising a light incident region and a light emergent region, wherein incident light from the light incident region is propagated in the optical waveguide and then is emitted from the light emergent region; and

a squeezed light field module, configured to synthesize a squeezed light field comprising a displayed image and emit the squeezed light field to the light incident region.

In an exemplary embodiment of the present disclosure, the squeezed light field module includes a beam splitter, a first spatial light modulator, and a second spatial light modulator.

In an exemplary embodiment of the present disclosure, an included angle between a surface where the first spatial light modulator is and a surface where the beam splitter is is 45 degrees, and the second spatial light modulator is positioned at a location a preset distance away from the first spatial light modulator with respect to a mirror image location of the beam splitter.

In an exemplary embodiment of the present disclosure, the squeezed light field module includes a first display panel and a second display panel arranged in parallel with the light incident region and sequentially arranged along a light incident direction.

In an exemplary embodiment of the present disclosure, the squeezed light field module includes a display panel and a varifocal lens arranged in parallel with the light incident region and sequentially arranged along a light incident direction.

In an exemplary embodiment of the present disclosure, the incident light from the light incident region being propagated in the optical waveguide and then being emitted from the light emergent region include: the incident light perpendicular to the light incident region being propagated in the optical waveguide and then being emitted from the light emergent region along a direction perpendicular to the light emergent region.

In an exemplary embodiment of the present disclosure, the display system also includes:

an incident holographic reflecting film arranged on the second surface and corresponding to the light incident region; and

an emergent holographic reflecting film arranged on the second surface and corresponding to the light emergent region.

In an exemplary embodiment of the present disclosure, the incident holographic reflecting film or the emergent holographic reflecting film is red-green-blue holographic reflecting film sequentially laminated.

In an exemplary embodiment of the present disclosure, the display system further includes a microlens array formed between the light emergent region and a human eye and paralleling to the first surface.

In an exemplary embodiment of the present disclosure, the microlens array is a double-layer microlens array.

In an exemplary embodiment of the present disclosure, the double-layer microlens array is formed into a Keplerian telescope ocular.

According to a second aspect of the present disclosure, there is disclosed a display method, which is applied to the foregoing display system. The display method includes:

synthesizing a squeezed light field comprising a displayed image by means of the squeezed light field module;

projecting and coupling the squeezed light field into the optical waveguide through the light incident region; and

coupling the squeezed light field out of the optical waveguide through the light emergent region.

In an exemplary embodiment of the present disclosure, the squeezed light field module includes a beam splitter, a first spatial light modulator, and a second spatial light modulator.

In an exemplary embodiment of the present disclosure, the squeezed light field module includes a first display panel and a second display panel arranged in parallel with the light incident region and sequentially arranged along a light incident direction.

In an exemplary embodiment of the present disclosure, the squeezed light field module includes a display panel and a varifocal lens arranged in parallel with the light incident region and sequentially arranged along a light incident direction.

It should be understood that the above general description and the detailed description below are merely exemplary and explanatory, and do not limit the present disclosure.

### BRIEF DESCRIPTION OF THE DRAWINGS

The above and other objectives, features and advantages of the present disclosure will become more apparent by describing in detail the exemplary embodiments thereof with reference to the accompanying drawings.

The accompanying drawings herein are incorporated in and constitute a part of this specification, illustrate embodiments conforming to the present disclosure and together with the description serve to explain the principles of the present disclosure. Apparently, the accompanying drawings in the following description show merely some embodiments of the present disclosure, and persons of ordinary skill in the art may still derive other drawings from these accompanying drawings without creative efforts.

FIG. 1 illustrates a schematic diagram of human eyes watching a real world;

FIG. 2 illustrates a schematic diagram of stereoscopic 3D display in related art;

FIG. 3 illustrates a schematic diagram of implementing light field display by a microlens array;

FIG. 4 illustrates a schematic diagram of laminated light field display based on multilayer screens;

FIG. 5 illustrates a schematic diagram of a display system according to an exemplary embodiment of the present disclosure;

FIG. 6 illustrates a schematic diagram of a laminated light field display based on a beam splitter according to an exemplary embodiment of the present disclosure;

FIG. 7 illustrates a schematic diagram of another embodiment of a squeezed light field module in a display system according to an exemplary embodiment of the present disclosure;

FIG. 8 illustrates a schematic diagram of still another embodiment of the squeezed light field module in a display system according to an exemplary embodiment of the present disclosure;

FIG. 9 illustrates a schematic diagram of another embodiment of an optical waveguide coupling squeezed light field in a display system according to an exemplary embodiment of the present disclosure; and

FIG. 10 illustrates a schematic diagram of a display method according to an exemplary embodiment of the present disclosure.

### DETAILED DESCRIPTION

Exemplary embodiments will be described more comprehensively by referring to accompanying drawings now. However, the exemplary embodiments may be carried out in various manners, and shall not be interpreted as being limited to the embodiments set forth herein. Furthermore, the described features, structures, or characteristics may be combined in any suitable manner in one or more embodiments. In the following description, numerous specific details are provided to provide a thorough understanding of the embodiments of the present disclosure. Those skilled in the art will recognize, however, that the technical solution of the present disclosure may be practiced without one or more of the specific details described, or that other methods, components, materials, etc. may be employed. It is to be pointed out that in the accompanying drawings, sizes of layers and regions may likely be exaggerated for clarity of illustration. In addition, it may be understood that when an element or layer is referred to as being “on” another element or layer, it may be directly on the other element, or intervening layers may be present. Furthermore, it may be understood that when an element or layer is referred to as being “beneath” another element or layer, it may be directly beneath the other element, or at least one intervening layer or element may be present. Moreover, it also may be understood that when a layer or element is referred to as being “between” two layers or two elements, it may be unique layer between the two layers or two elements, or at least one intervening layer or element may be present. Throughout the specification, similar reference numerals indicate similar elements.

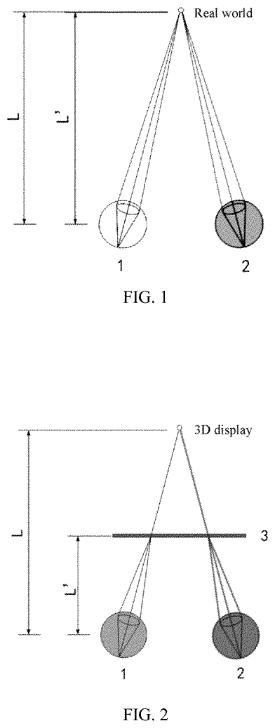

FIG. 1 illustrates a schematic diagram of human eyes watching a real world. FIG. 2 illustrates a schematic diagram of stereoscopic 3D display in related art. Referring to FIG. 1-2 (reference numerals 1, 2 and 3 in the figures respectively represent the left eye, the right eye and the display screen, and L and L′ respectively represent the convergence distance and the focusing distance). FIG. 1 illustrates a schematic diagram of human eyes watching a real world, and FIG. 2 illustrates a schematic diagram of stereoscopic 3D display in related technologies. As shown in FIG. 1 and FIG. 2, when the human eyes watch the real world, the convergence distance L is equal to the focusing distance L′, and thus there does not exist the problem of convergence-accommodation conflict (i.e., contradiction between focusing and focalizing). Whereas the convergence distance L differs greatly from the focusing distance L′ in the stereoscopic 3D display, and thus the problem of convergence-accommodation conflict is relatively obvious.

An objective of the present disclosure is to provide a display system and a display method. The display system includes: an optical waveguide, which has a first surface and a second surface in parallel with the first surface, wherein the first surface includes a light incident region and a light emergent region, and incident light from the light incident region is propagated in the optical waveguide and then is emitted from the light emergent region; and a squeezed light field module, configured to synthesize a squeezed light field including a displayed image and emit the squeezed light field to the light incident region. The light field is projected and coupled into the optical waveguide, and then the light field is coupled out of the optical waveguide, such that the light field is visible to the human eyes. In this way, the near-eye display (for example, AR or VR) mode and the light field display may be implemented, the contradiction between focusing and focalizing may be avoided, making the human eyes feel natural and comfortable without dizziness, and thus solving the problems of dizziness and visual fatigue caused when the human eyes watch a stereoscopic 3D image formed by two parallactic two-dimensional images for a long time. In the meanwhile, the display effect of the light field is further enhanced by arranging a microlens array between the light emergent region of the optical waveguide and the human eyes. Furthermore, while the display effect of the light field is further enhanced, the field angle is increased by arranging, between the light emergent region of the optical waveguide and the human eyes, a double-layer microlens array formed into a Keplerian telescope ocular.

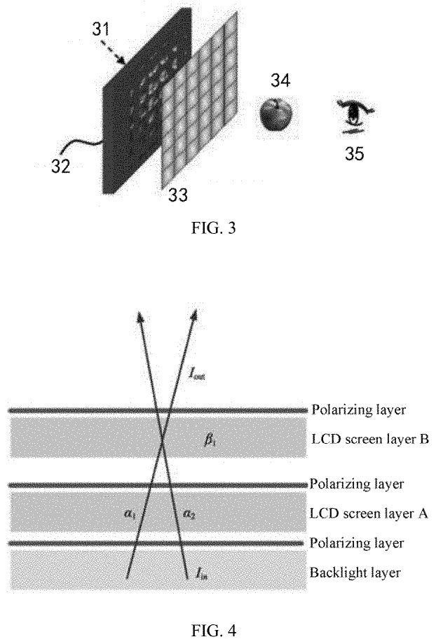

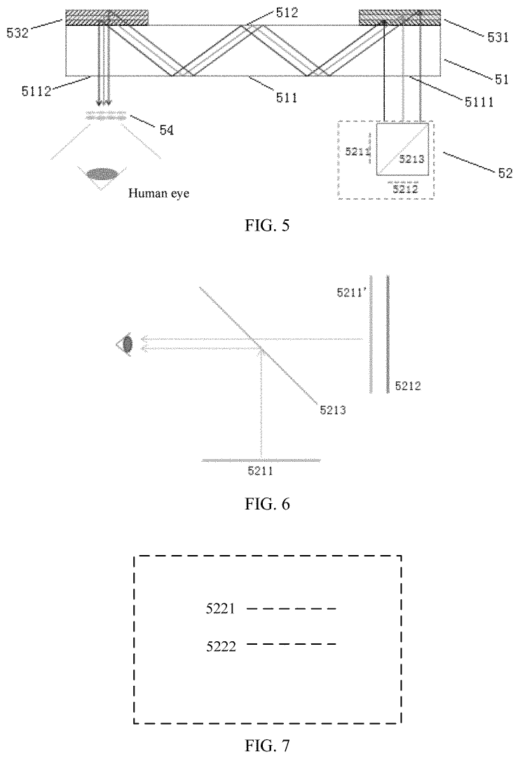

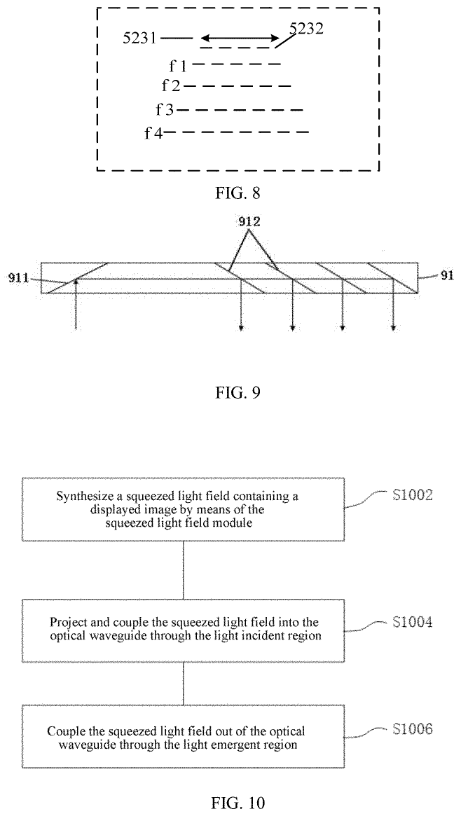

The display system of the present disclosure is described below with reference to FIG. 3-FIG. 9. FIG. 3 illustrates a schematic diagram of implementing light field display by the microlens array. FIG. 4 illustrates a schematic diagram of laminated light field display based on multilayer screens. FIG. 5 illustrates a schematic diagram of a display system according to an exemplary embodiment of the present disclosure. FIG. 6 illustrates a schematic diagram of a laminated light field display based on a beam splitter according to an exemplary embodiment of the present disclosure. FIG. 7 illustrates a schematic diagram of another embodiment of a squeezed light field module in a display system according to an exemplary embodiment of the present disclosure. FIG. 8 illustrates a schematic diagram of still another embodiment of the squeezed light field module in a display system according to an exemplary embodiment of the present disclosure. FIG. 9 illustrates a schematic diagram of another embodiment of an optical waveguide coupling squeezed light field in a display system according to an exemplary embodiment of the present disclosure.

The light field display provides a feasible method to solve the problems of a user's eye fatigue and dizziness. By simulating the light field of a natural 3D object, natural 3D display is implemented, and thus the human eye fatigue and dizziness are reduced. There are a variety of ways to implement the light field display. Implementations of the light field display adopted in the present disclosure are respectively introduced below.

First, the light field display based on the microlens array is introduced. Integrated imaging display using the microlens array is one of the ways to implement the light field display. As shown in FIG. 3 (reference numerals 31-35 in FIG. 3 respectively represent a natural image, a display screen, a microlens array, a 3D image, and an observer). The two-dimensional natural image (a planar apple) 31 as shown in the display screen 32 is formed into the three-dimensional image 34 (a three-dimensional apple) by the microlens array 33. In this way, the light field display is implemented.

Next, principles of laminated light field display based on a multi-layer screen are introduced as below. Liquid crystal screens or other types of display panels/display screens are used as spatial light modulating units for multi-layer light field display. Light intensities of incident rays (from a backlight source) are modulated by adjusting gray values of corresponding pixels or even sub-pixels between layers. The gray values of the pixels corresponding to each layer of liquid crystal screen determine light intensity transmission rate. As shown in FIG. 4, using the concept of a 4D light field, α₁, α₂ and β₁ respectively are pixel positions of the A^{th} layer and the B^{th} layer. The output light intensity of two beams of light rays may be expressed as

I_{OUT}(α₁,β₁)=Iᵢₙ×T_{A}(α₁)+β×T_{B}(β₁)

I_{OUT}(α₂,β₁)=Iᵢₙ×T_{A}(α₂)+β×T_{B}(β₁)

wherein T_{A} (α₁) and T_{A} (α₂) respectively represent the light intensity transmission rate of the A^{th} layer at the positions of α₁ and α₂. Likewise, T_{B} (β₁) represents the light intensity transmission rate of the B^{th} layer at the position of β₁. Therefore, the two beams of light rays have different light intensities. Based on this model, although different light rays may pass through the same pixel of a certain layer of liquid crystal screen, they necessarily will pass through different pixels of another layer of screen spaced at a certain distance. Therefore, information on different light field intensities is implemented. Based on this principle, regulation and control of the light field may be implemented by controlling displayed images of different layers of liquid crystal screens. The key to reconstructing the light field is to calculate the gray value of each pixel in each layer of images, and compare the reconstructed light field with the target light field, such that the optimal solution is found by providing an initial structure and using an iterative algorithm. The specific algorithm is not described any more here. In simple terms, the direction of the light rays may be determined by uniquely determining a point on two planes respectively. The light intensities of the light rays in different directions may be determined by modulating gray scales of pixel points on a double-layer screen. Likewise, it may be extended to a multi-layer screen or a multi-layer screen plus directional backlight, and then time division multiplexing is carried out. In this way, tensor light field display or multi-layer screen light field display may be implemented. In the present disclosure, it is only needed to consider multiframe display of a double-layer display screen.

As shown in FIG. 5, the display system of the present disclosure includes an optical waveguide 51, which has a first surface 511 and a second surface 512 in parallel with the first surface 511. The first surface 511 includes a light incident region 5111 and a light emergent region 5112. In a possible embodiment, the first surface 511 is positioned on a side close to the human eye. The light emergent region is positioned at one end of the optical waveguide corresponding to the human eye, and the light incident region is positioned at the other end of the optical waveguide far away from the light incident region. Incident light from the light incident region is propagated in the optical waveguide and then is emitted from the light emergent region. The display system further includes a squeezed light field module 52, which is configured to synthesize a squeezed light field containing a displayed image and emit the squeezed light field to the light incident region. The squeezed light field is projected and coupled into the optical waveguide 21, and then the light field is coupled out of the optical waveguide, such that the light field is visible to the human eyes. In this way, the near-eye display mode and the light field display may be implemented, and the contradiction between focusing and focalizing may be avoided, making human eyes feel natural and comfortable without dizziness, and thus solving the problems of dizziness and visual fatigue caused when the human eyes watch a stereoscopic 3D image formed by two parallactic two-dimensional images for a long time.

In an exemplary embodiment of the present disclosure, the squeezed light field module 52 includes a beam splitter 5213, a first spatial light modulator 5211, and a second spatial light modulator 5212.

The spatial light modulator (SLM) can modulate a certain parameter of the light field through liquid crystal molecules under active control, for example, by modulating the amplitude of the light field, by modulating the phase through a refractive index, and by modulating a polarization state by means of rotation of a polarization plane, or implement conversion from incoherent light to coherent light, so that certain information is written into the optical wave to achieve the objective of optical wave modulation. The SLM can conveniently load information into a one-dimensional or two-dimensional light field, and can utilize advantages of wide bandwidth of light and multi-channel parallel processing to quickly process the loaded information. The most common spatial light modulator is a liquid crystal light valve, which is widely used in optical computing, pattern recognition, information processing, display, imaging and projection, etc. In this exemplary embodiment, two spatial light modulators are used and respectively arranged on two sides of the beam splitter to synthesize a 4D squeezed light field. Actually, the aforementioned principles of laminated light field display based on a multi(two)-layer screen are still adopted, and its optical principles are as shown in FIG. 6. The beam splitter is a half mirror. The spatial light modulator is equivalent to the display panel/display. The half mirror is utilized to separate the two spatial light modulators in space. Like the second spatial light modulator 5212, the mirror image 5211′ of the first spatial light modulator 5211 forms the display effect of the laminated light field display based on the multi(two)-layer screen. Furthermore, the second spatial light modulator 5212 does not pass through the first spatial light modulator 5211 on the optical path, and there is no mutual interference, which reduces crosstalk.

In an exemplary embodiment of the present disclosure, an included angle between a surface where the first spatial light modulator is and a surface where the beam splitter is is 45 degrees, and the second spatial light modulator is positioned at a location a preset distance away from the first spatial light modulator 5211 with respect to a mirror image location of the beam splitter. That is, the first spatial light modulator and the second spatial light modulator are disposed symmetrically with respect to the beam splitter.

As shown in FIG. 7, in an exemplary embodiment of the present disclosure, the squeezed light field module 52 includes a first display panel 5221 and a second display panel 5222 arranged in parallel with the light incident region and sequentially arranged along a light incident direction. In this exemplary embodiment, the aforementioned laminated light field display mode based on a multi(two)-layer screen are still adopted, and thus their detailed descriptions are omitted here.

As shown in FIG. 8, in an exemplary embodiment of the present disclosure, the squeezed light field module 52 includes a display panel 5231 and a varifocal lens 5232 arranged in parallel with the light incident region and sequentially arranged along a light incident direction. This exemplary embodiment is another embodiment for implementing the light field display. A layer of varifocal lens such as a liquid crystal lens (LC lens) may be added on the display panel such as a liquid crystal display (LCD). The imaging position on the LCD may be changed by adjusting the focal length of the LC lens. When the LC lens and the LCD are high in refresh rate and the focal length of the LC lens matches with the frame of the LCD, the principle of “persistence of vision” of the human eyes may be utilized to “simultaneously” display images of different depths of field. The display principles are as follows: an LC lens array with a variable focal length is placed in front of the LCD, and the frame of the LCD and the focal length of the LC lens are adjusted within time of “one frame”, such that different frames and focal lengths are respectively displayed at 1/5 frame, 2/5 frame, 3/5 frame, 4/5 frame and 5/5 frame to form images of longitudinal depth of field. The human eye can focus on any depth of field to observe images and produce a stereoscopic sensation. For example, if an image of five depths of field is to be displayed, the light field display scheme requires that the LC lens has four focal lengths f1-f4, and the original one frame needs to be divided into four frames to display.

In an exemplary embodiment of the present disclosure, the incident light from the light incident region being propagated in the optical waveguide and then being emitted from the light emergent region include: the incident light perpendicular to the light incident region being propagated in the optical waveguide and then being emitted from the light emergent region along a direction perpendicular to the light emergent region, such that the emergent light enters the human eyes at the best angle and it is ensured to reach the optimal visual effect.

In an exemplary embodiment of the present disclosure, the display system also includes: an incident holographic reflecting film 531 arranged on the second surface and corresponding to the light incident region, and an emergent holographic reflecting film 532 arranged on the second surface and corresponding to the light emergent region.

In an exemplary embodiment of the present disclosure, the incident holographic reflecting film or the emergent holographic reflecting film is red-green-blue (RGB) holographic reflecting film sequentially laminated. Light rays of RGB wavelengths in the light field are respectively coupled into the optical waveguide through the RGB holographic reflecting film, which may reflect light rays having a particular wavelength and a particular incident angle. On the other side of the optical waveguide, the holographic reflecting film couples the light rays of the light field out of the optical waveguide. However, the present disclosure is not limited thereto. As shown in FIG. 9, an incident reflecting plane 911 may be arranged at a position in the optical waveguide 91 corresponding to the light incident region, and an emergent reflecting plane 912 may be arranged at a position in the optical waveguide corresponding to the light emergent region. In this way, the objective of coupling the light rays in the light field into the optical waveguide such that the light rays propagate in the optical waveguide and then coupling the light rays in the light field out of the optical waveguide also may be implemented (positions of the light incident region and the light emergent region of the optical waveguide in FIG. 9 are just the opposite to those in FIG. 5, thus there is no special restrictions on the positions of the light incident region and the light emergent region of the optical waveguide because the technical effects of the present disclosure may be implemented in any case).

In an exemplary embodiment of the present disclosure, the display system further includes a microlens array 54 formed between the light emergent region and a human eye and paralleling to the first surface of the optical waveguide. The integrated imaging display using the microlens array is one of methods for implementing the light field display. In this exemplary embodiment, the display effect of the light field is further enhanced by arranging a microlens array between the light emergent region of the optical waveguide and the human eyes.

In addition to using a single-layer microlens array, a double-layer microlens array also may be used. As shown in FIG. 5, the double-layer cylindrical microlens film is employed to form an ocular. The lens near the eye has a smaller focal length (the lens is thicker), and the lens near the optical waveguide has a larger focal length (the lens is thinner) to constitute a micro-cylindrical lens array (a Doppler telescope array). Furthermore, microlenses in the two layers correspond one to one, which is equivalent to a fact that the double-layer microlens array is formed into a Keplerian telescope ocular, which may widen the field of view (FOV) of the light field propagated through the optical waveguide. That is, while the display effect of the light field is further enhanced, the field angle is increased by arranging, between the light emergent region of the optical waveguide and the human eyes, a double-layer microlens array formed into a Keplerian telescope ocular.

In the following, reference is made to the display method of the present disclosure with reference to FIG. 10. As shown in FIG. 10, the display method applied to the foregoing display system is as below.

In Step S1002, a squeezed light field containing a displayed image is synthesized by means of the squeezed light field module.

In Step S1004, the squeezed light field is projected and coupled into the optical waveguide through the light incident region.

In Step S1006, the squeezed light field is coupled out of the optical waveguide through the light emergent region.

In an exemplary embodiment of the present disclosure, the squeezed light field module includes a beam splitter, a first spatial light modulator, and a second spatial light modulator.

In an exemplary embodiment of the present disclosure, the squeezed light field module includes a first display panel and a second display panel arranged in parallel with the light incident region and sequentially arranged along a light incident direction.

In an exemplary embodiment of the present disclosure, the squeezed light field module includes a display panel and a varifocal lens arranged in parallel with the light incident region and sequentially arranged along the light incident direction.

Through the above detailed description, those skilled in the art readily understand that the display system according the embodiments of the present disclosure have one or more of the following advantages.

According to some embodiments of the present disclosure, the light field is projected and coupled into the optical waveguide, and then the light field is coupled out of the optical waveguide, such that the light field is visible to the human eyes. In this way, the near-eye display mode and the light field display may be implemented, and the contradiction between focusing and focalizing may be avoided, making human eyes feel natural and comfortable without dizziness, and thus solving the problems of dizziness and visual fatigue caused when the human eyes watch a stereoscopic 3D image formed by two parallactic two-dimensional images for a long time.

According to some other embodiments of the present disclosure, the display effect of the light field is further enhanced by arranging a microlens array between the light emergent region of the optical waveguide and the human eyes.

According to still some other embodiments of the present disclosure, while the display effect of the light field is further enhanced, the field angle is increased by arranging, between the light emergent region of the optical waveguide and the human eyes, a double-layer microlens array formed into a Keplerian telescope ocular.

Other embodiments of the present disclosure will be apparent to those skilled in the art from consideration of the specification and practice of the invention disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present invention being indicated by the following claims.

It will be appreciated that the present disclosure is not limited to the exact construction that has been described above and illustrated in the accompanying drawings, and that various modifications and changes can be made without departing from the scope thereof. The scope of the present disclosure is only restricted by the appended claims.

1. A display system, comprising:
an optical waveguide, having a first surface and a second surface in parallel with the first surface, the first surface comprising a light incident region and a light emergent region, wherein incident light from the light incident region is propagated in the optical waveguide and then is emitted from the light emergent region; and
a squeezed light field module, configured to synthesize a squeezed light field comprising a displayed image and to emit the squeezed light field to the light incident region.

2. The display system according to claim 1, wherein the squeezed light field module comprises a beam splitter, a first spatial light modulator, and a second spatial light modulator.

3. The display system according to claim 2, wherein an included angle between a surface where the first spatial light modulator is located and a surface where the beam splitter is located is 45 degrees, and the second spatial light modulator is positioned at a location a preset distance away from the first spatial light modulator with respect to a mirror image location of the beam splitter.

4. The display system according to claim 1, wherein the squeezed light field module comprises a first display panel and a second display panel arranged in parallel with the light incident region and sequentially arranged along a light incident direction.

5. The display system according to claim 1, wherein the squeezed light field module comprises a display panel and a varifocal lens arranged in parallel with the light incident region and sequentially arranged along a light incident direction.

6. The display system according to claim 1, wherein the incident light from the light incident region being propagated in the optical waveguide and then being emitted from the light emergent region comprise: the incident light perpendicular to the light incident region being propagated in the optical waveguide and then being emitted from the light emergent region along a direction perpendicular to the light emergent region.

7. The display system according to claim 1, further comprising:
an incident holographic reflecting film arranged on the second surface and corresponding to the light incident region; and
an emergent holographic reflecting film arranged on the second surface and corresponding to the light emergent region.

8. The display system according to claim 7, wherein the incident holographic reflecting film or the emergent holographic reflecting film is red-green-blue holographic reflecting film sequentially laminated.

9. The display system according to claim 1, further comprising a microlens array formed between the light emergent region and a human eye and paralleling to the first surface.

10. The display system according to claim 9, wherein the microlens array is a double-layer microlens array.

11. The display system according to claim 10, wherein the double-layer microlens array is formed into a Keplerian telescope ocular.

12. A display method, applied to a display system comprising:
an optical waveguide, having a first surface and a second surface in parallel with the first surface, the first surface comprising a light incident region and a light emergent region, wherein incident light from the light incident region is propagated in the optical waveguide and then is emitted from the light emergent region; and
a squeezed light field module, configured to synthesize a squeezed light field comprising a displayed image and emit the squeezed light field to the light incident region,
wherein the display method comprises:
synthesizing a squeezed light field comprising a displayed image by means of the squeezed light field module;
projecting and coupling the squeezed light field into the optical waveguide through the light incident region; and
coupling the squeezed light field out of the optical waveguide through the light emergent region.

13. The display method according to claim 12, wherein the squeezed light field module comprises a beam splitter, a first spatial light modulator, and a second spatial light modulator.

14. The display method according to claim 12, wherein the squeezed light field module comprises a first display panel and a second display panel arranged in parallel with the light incident region and sequentially arranged along a light incident direction.

15. The display method according to claim 12, wherein the squeezed light field module comprises a display panel and a varifocal lens arranged in parallel with the light incident region and sequentially arranged along a light incident direction.

16. The display system according to claim 2, wherein the incident light from the light incident region being propagated in the optical waveguide and then being emitted from the light emergent region comprise: the incident light perpendicular to the light incident region being propagated in the optical waveguide and then being emitted from the light emergent region along a direction perpendicular to the light emergent region.

17. The display system according to claim 3, wherein the incident light from the light incident region being propagated in the optical waveguide and then being emitted from the light emergent region comprise: the incident light perpendicular to the light incident region being propagated in the optical waveguide and then being emitted from the light emergent region along a direction perpendicular to the light emergent region.

18. The display system according to claim 2, further comprising:
an incident holographic reflecting film arranged on the second surface and corresponding to the light incident region; and
an emergent holographic reflecting film arranged on the second surface and corresponding to the light emergent region.

19. The display system according to claim 3, further comprising:
an incident holographic reflecting film arranged on the second surface and corresponding to the light incident region; and
an emergent holographic reflecting film arranged on the second surface and corresponding to the light emergent region.

20. The display method according to claim 13, wherein an included angle between a surface where the first spatial light modulator is located and a surface where the beam splitter is located is 45 degrees, and the second spatial light modulator is positioned at a location a preset distance away from the first spatial light modulator with respect to a mirror image location of the beam splitter.
